(19) United States
(12) Patent Application Publication
(10) Pub. No.: US 2013/0058496 A1
(43) Pub. Date: Mar. 7, 2013

(54) Audio Noise Optimizer

(71) Applicant: John Harris, Glenview, IL (US)

(72) Inventor: John Harris, Glenview, IL (US)

(73) Assignee: Nokia Siemens Networks US LLC

(21) Appl. No.: 13/226,805

(22) Filed: Sep. 7, 2011

(51) Int. Cl. H04B 15/00

(52) U.S. Cl. 381/94.1

(57) ABSTRACT

The specification and drawings present a new method, apparatus and software related product (e.g., a computer readable memory) for implementing reducing audio noise in audio related communications (e.g., telephone communications) by analyzing audio signals from/to users (or user equipments) in a close proximity to one another, e.g., e.g., in the same geographic location or for calls under the same cell. Also pre-recorded signals or real-time broadcasting signals may be used for identifying and canceling/reducing unwanted noises in various audio related communications.

### TECHNICAL FIELD

The exemplary and non-limiting embodiments of this invention relate generally to audio communications and more specifically to reducing audio noise by analyzing audio signals from multiple users, prerecorded signals and real-time broadcasting signals.

### BACKGROUND ART

Noise in a telephone communication including cellular phone calls, VoIP (voice over Internet Protocol) calls, video calls, video recording, landline wired calls, etc. can be a significant cause of user frustration.

Noise canceling/reduction techniques are usually rather complex and expensive having limited capabilities and applications. For example, multiple microphones, e.g., first microphone facing away from the speaker and the second facing towards the speaker, may be used for reducing the noise by subtracting a scaled audio signal received by the first microphone from the audio signal received by the second microphone. However, this method would become ineffective, for example in a speakerphone mode of operation. Another possible approach is disclosed in Japanese Patent Application Number JP09046250 where the audio noise canceling is directed to removing wind noise, using signal frequency analysis, which may have a rather limited practical application for telephone communications.

The embodiments described herein contribute to the solution for a noise reduction in audio related communications (e.g., telephone wireless communications).

### SUMMARY

According to a first aspect of the invention, a method comprises: providing, by an audio noise optimizer, a first electrical signal indicative of an audio signal received from a first user equipment of a plurality of user equipments, each user equipment of the plurality of user equipments being used by a different user; identifying a noise signal in the first electrical signal; comparing the noise signal with one or more of: at least one further electrical signal indicative of at least one further audio signal received from or to be sent to at least one further user equipment of the plurality of user equipments by the audio noise optimizer, real-time broadcasting signals and pre-recorded database signals; and if a match is found between the noise signal and one or more of: the at least one further electrical signal, a real-time broadcasting signal of the real-time broadcasting signals and a pre-recorded database signal of the pre-recorded database signals, subtracting from the first electrical signal one or more appropriately scaled and synchronized versions of: the at least one further signal, the real-time broadcasting signal and the pre-recorded database signal.

According to a second aspect of the invention, an apparatus comprises: an audio noise optimizer; and at least one processor and at least one memory storing computer readable instructions, the audio noise optimizer, using the computer readable instructions and the at least one processor, is configured to: provide a first electrical signal indicative of an audio signal received from a first user equipment of a plurality of user equipments, each user equipment of the plurality of user equipments being used by a different user; identify a noise signal in the first electrical signal; perform comparing the noise signal with at least one further electrical signal indicative of at least one further audio signal received from or to be sent to at least one further user equipment of the plurality of user equipments by the audio noise optimizer, real-time broadcasting signals and pre-recorded database signals; and if a match is found between the noise signal and one or more of: the at least one further electrical signal, a real-time broadcasting signal of the real-time broadcasting signals and a pre-recorded database signal of the pre-recorded database signals, subtract from the first electrical signal one or more appropriately scaled and synchronized versions of: the at least one further signal, the real-time broadcasting signal and the pre-recorded database signal.

According to a third aspect of the invention, a non-transitory computer readable memory encoded with a computer program comprising computer readable instructions recorded thereon for execution of a method which comprises: providing, by an audio noise optimizer, a first electrical signal indicative of an audio signal received from a first user equipment of a plurality of user equipments, each user equipment of the plurality of user equipments being used by a different user; identifying a noise signal in the first electrical signal; comparing the noise signal with one or more of: at least one further electrical signal indicative of at least one further audio signal received from or to be sent to at least one further user equipment of the plurality of user equipments by the audio noise optimizer, real-time broadcasting signals and pre-recorded database signals; and if a match is found between the noise signal and one or more of: the at least one further electrical signal, a real-time broadcasting signal of the real-time broadcasting signals and a pre-recorded database signal of the pre-recorded database signals, subtracting from the first electrical signal one or more appropriately scaled and synchronized versions of: the at least one further signal, the real-time broadcasting signal and the pre-recorded database signal.

### BRIEF DESCRIPTION OF THE DRAWINGS

For a better understanding of the nature and objects of the present invention, reference is made to the following detailed description taken in conjunction with the following drawings, in which:

FIG. 1 is a system block diagram for implementing embodiments of the invention;

FIGS. 2a and 2b are diagrams demonstrating a concept of removing/reducing noise when noise is originated from a “close proximity” user who is in a listening mode of operation (FIG. 2a) and in a talking mode of operation (FIG. 2b), according to embodiments of the invention;

FIG. 3 is a diagram demonstrating a concept of removing/reducing noise using a real-time broadcasting or a pre-recorded audio, according to an embodiment of the invention;

FIG. 4 is a flow chart of an audio noise optimization according to exemplary embodiments of the invention; and

FIG. 5 is a block diagram of an audio noise optimizer according to an embodiment of the invention.

### DETAILED DESCRIPTION

A new method, apparatus, and software related product (e.g., a computer readable memory) are presented for reducing audio noise in audio communications (e.g., telephone communications) by analyzing audio signals from/to users (or user equipments) in a close proximity to one another, e.g., in the same geographic location or for calls under the same cell. Also pre-recorded signals or real-time broadcasting signals may be used for identifying and canceling/reducing unwanted noises in various audio related communications. Various implementations may be performed in analog and/or digital domains.

The embodiments described herein may be applicable to a broad range of audio related communications including, but not limited to: telephony (both wireless and wired), voice-recognition and other applications such as video telephony or video recording for posting, e.g., FACEBOOK, etc. For example, services like GOOGLE (GOOGLE VOICE), MICROSOFT (SKYPE), APPLE (FACE TIME), operators, and the like may be offering to users services for audio noise optimization/reduction, as disclosed herein. Users may be given the option to activate/deactivate the feature, i.e., to remove the background noise or not.

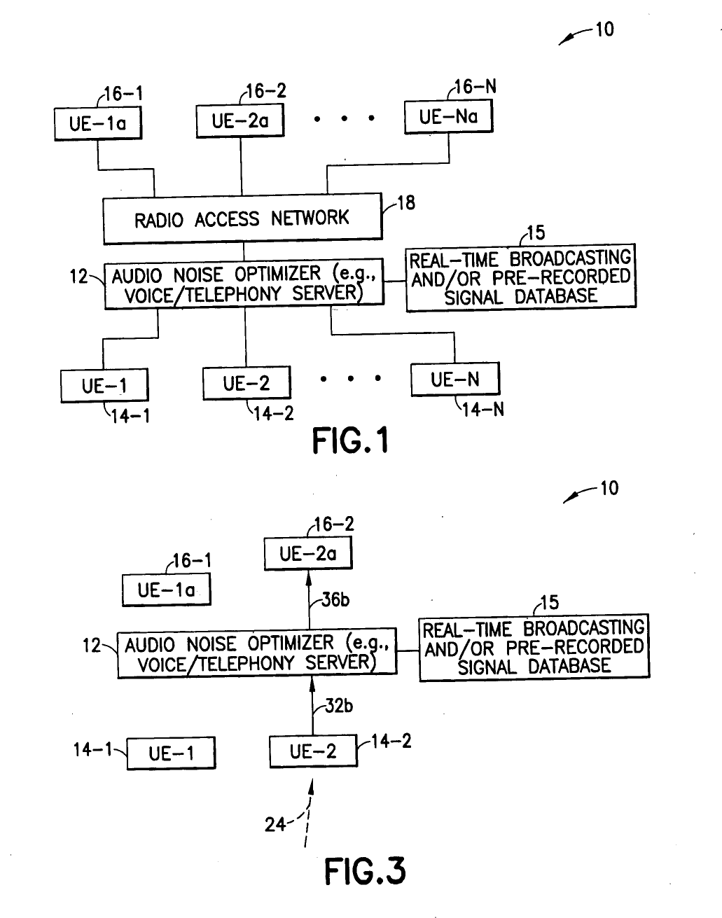

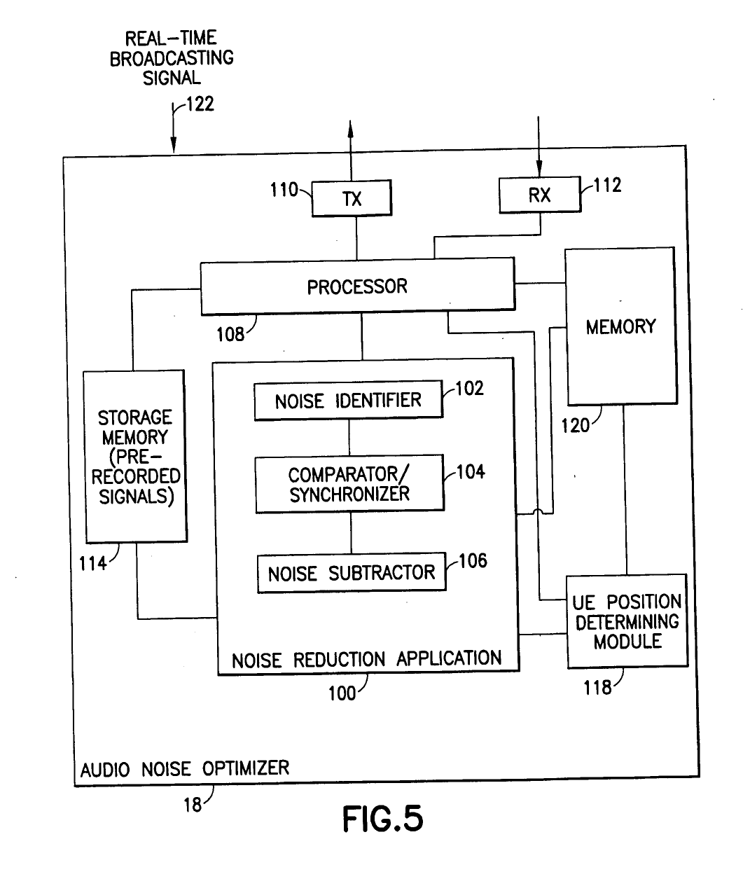

Various embodiments of the invention are illustrated in FIGS. 1-5.

FIG. 1 shows an example of a block diagram of a system 10 for implementing embodiments of the invention. User equipments (UEs) 16-1, 16-2, . . . 16-N are wireless devices used for audio related wireless communications in a radio network 18 providing access to an audio noise optimizer 12, which may be a server, a phone server, a voice server, a node in a communication system or the like. The audio noise optimizer 12 can be also called an audio optimizer, a noise optimizer or a voice optimizer. The audio noise optimizer 12 may reside outside of the radio access network 18 as shown in FIG. 1 or it may be a part of the radio access network 18. The UEs 14-1, 14-2, . . . 14-N may be wireless or wired devices and have an access to the audio noise optimizer 12 as shown in FIG. 1. It is noted that additional intermediate nodes between any of the UEs 14-1, 14-2, . . . 14-N and the audio noise optimizer 12 (not shown in FIG. 1) may be used for facilitating the communication between them. It is further noted that each UE in FIG. 1 is used by a different user. The UE may be a mobile phone, a camera phone, a video phone, a portable device, a computer, a wired device or the like.

In the example shown in FIG. 1 each pair of users may be engaged in a one-to-one telephony call, e.g., the UE 14-1 is talking to the UE 16-1, the UE 14-2 is talking to the UE 16-2, etc., wherein each UE is used by a different user. Also other types of communications such as a conference call between multiple users may be a subject for applying the embodiments of the invention. Furthermore, a location estimate for the users (or UEs) may be generated through a variety of known mechanisms such as GPS (Global Positioning System), cellular location applications like NAVIZON and the like. This information is then used in exemplary embodiments to identify users (or UEs) which are likely acoustically proximate to one another. The criterion for selecting active UEs in a close proximity to the UE selected for reducing the noise in the audio signal generated and sent by that UE may be (but limited to) one or more of: a minimum distance to that UE from the selected UEs (e.g., from the GPS data), UEs using the same cell in a wireless network, UEs using a speakerphone, etc.

Moreover, a module 15 may comprise a memory with a library of stored pre-recorded sound patterns (e.g., popular music, sirens, etc.) and/or can provide real-time access to broadcasting soundtracks (TV/radio). The module 15 may be a part of the audio noise optimizer 12.

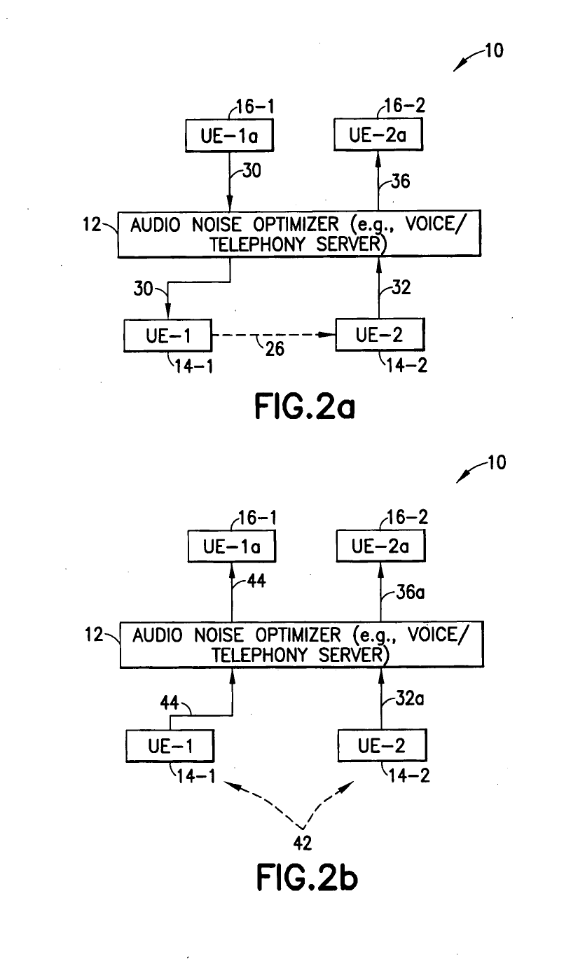

Various exemplary embodiments for audio noise cancelation/reduction are further discussed in reference to FIGS. 2a, 2b, 3, 4 and 5.

FIG. 2a shows an example among others demonstrating a concept of removing/reducing noise in an audio signal 32 originated from the UE 14-2 and received (and converted, if received wirelessly, into a corresponding electrical signal) by the audio noise optimizer 12 when another audio signal 30 (originated by the UE 16-1) is sent to the UE 14-1 which is in close proximity to the UE 14-2. In this scenario the audio signal 30 received by the UE 14-1 may be played, e.g., over the UE 14-1 speakerphone, which may be sensed as signal 26 by a microphone of the second UE 14-2 and therefore may be present as noise (or background noise) in the audio signal 32 recorded by the UE 14-2.

After the audio noise optimizer 12 identifies the UE 14-1 as being near (in a close proximity) to the transmitting UE 14-2 using one of the known methods such as GPS or the like, it compares the signal 32 with the signal 30. For example, the audio noise optimizer 12 can identify a noise in a signal 32 during a silent time period (e.g., when the user of the UE 14-2 is silent and listening to the UE 16-2) and then compare (e.g., cross-correlate in a time domain using time synchronization with a variable time delay) the noise identified in the signal 32 during the silent period with the signal 30. If a correlation or a match is found, e.g., a correlation factor (or a scale value) is greater than a pre-defined first threshold level for identifying a presence of the cross-correlation, then the audio noise optimizer 12 subtracts a properly scaled and synchronized audio signal 30 from the signal 32 to remove the audio noise (caused by the close proximity of the UEs 14-2 and 14-1) from the signal 32.

Then the audio noise optimizer 12 may check if a resultant signal after the subtracting meets a pre-defined criterion (e.g., the noise is below a further pre-defined threshold), and if the pre-defined criterion is met, generate and send the resultant audio signal 36 to the UE 16-2 which is in a communication session with the UE 14-2. If the pre-defined criterion is not met, the audio noise optimizer 12 may continue looking for other alternatives to reduce noise as shown and explained herein in reference to FIGS. 2b and 3-5.

It is noted that the noise subtraction in the example shown in FIG. 2a is performed for a time period when the UE 14-1 is in a listening mode of operation. When the UE 14-1 switches to the talking mode of operation, the noise reduction/cancelation may be performed according to the methodology described in reference to FIG. 2b.

FIG. 2b shows an example among others demonstrating a concept of removing/reducing noise in an audio signal 32a originated from the UE 14-2 and received (and converted, if received wirelessly, into a corresponding electrical signal) by the audio noise optimizer 12 when another audio signal 44 originated by the UE 14-1 located in close proximity to the UE 14-2 is sent to the UE 16-1. In this scenario, the audio/voice signal 42 from the user of the UE 14-1 may be sensed/detected by microphones of both the UE 14-1 and the UE 14-2, whereas for the UE 14-2 the detected signal 42 is noise.

After the audio noise optimizer 12 identifies the UE 14-1 as being in a close proximity to the transmitting UE 14-2 using one of the known methods such as GPS or the like, it compares the signal 32a with the signal 44. For example, the audio noise optimizer 12 can identify a noise in the signal 32a during a silent time period (e.g., when the user of the UE 14-2 is silent and listening to the UE 16-2) and then compare (e.g., cross-correlate in a time domain using time synchronization with a variable time delay) the noise identified in the signal 32a during the silent period with the signal 44. If a proper correlation or a match is found, e.g., a correlation factor (or a scale value) is greater than a pre-defined first threshold level for identifying a presence of the cross-correlation and less than a second threshold level, then the audio noise optimizer 12 subtracts a properly scaled and synchronized audio signal 44 from the signal 32a to remove the audio noise (caused by the close proximity of the UEs 14-2 and 14-1) from the signal 32a.

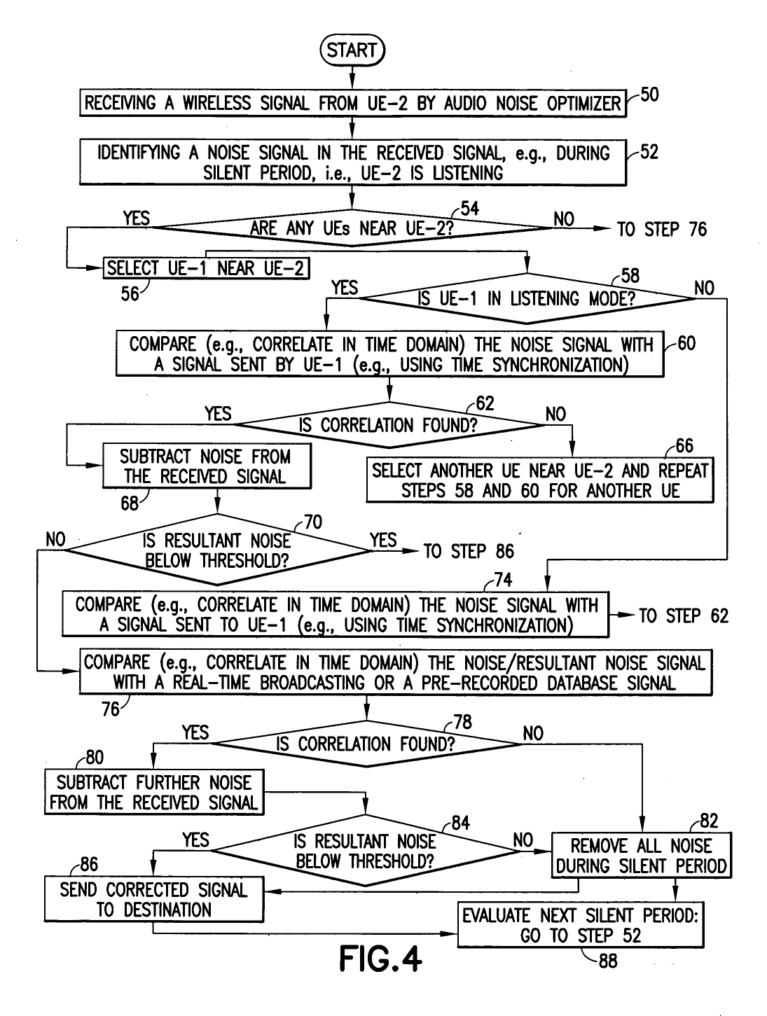

The second threshold level may be defined as a critical ratio of the amplitude of the noise signal identified in the signal 32a to the corresponding amplitude of the audio signal 44. In other words, it is expected (because the user of the UE 14-2 is closer to the microphone of the UE 14-2 than the user of the UE 14-1) that the noise identified in the signal 32a (as an indication of the detected audio/voice signal 42 from the user of the UE 14-1) should be quite less that the signal 44 (because the user of the UE 14-2 is closer to the UE 14-2 than to the UE 14-1). If that is not the case and the signal amplitudes are of approximately equal value, this would mean that the source of noise is not from the UE 14-1 and may be caused by a “common outside/background noise” which is disclosed in further discussion of FIGS. 3 and 4.

After the subtracting, the audio noise optimizer 12 may check if a resultant signal after the subtracting meets a pre-defined criterion (e.g., the noise is below the further pre-defined threshold), and if the pre-defined criterion is met, generate and send the resultant audio signal 36a to the UE 16-2 which is in a communication session with the UE 14-2. If the pre-defined criterion is not met, the audio noise optimizer 12 may continue looking for other alternatives to reduce noise as shown and explained herein in reference to FIGS. 2b and 3-5.

It is noted that the noise subtraction in the example shown in FIG. 2b is performed for a time period when the UE 14-1 is sending a signal to the UE 16-1, i.e., the UE 14-1 is in a talking mode. When the UE 14-1 switches to the listening mode, the noise reduction/cancelation may be performed according to the methodology described in reference to FIG. 2a.

FIG. 3 shows another example demonstrating a concept of removing/reducing noise when an environmental noise 24 in an audio signal 32b is identified using a real-time broadcasting (e.g., TV, radio) or a pre-recorded audio (e.g., well known songs, music, etc.), according to an embodiment of the invention.

The audio noise optimizer 12 can identify noise in the signal during a silent time period (e.g., when the user of the UE 14-2 is silent and listening to the UE 16-2) and then compare (e.g., cross-correlate in a time domain using time synchronization with a variable time delay) the noise identified in the signal 32b during the silent period with real-time broadcasting signals and/or pre-recorded database signals available to the audio noise optimizer 12.

If a proper correlation or a match is found, i.e., a correlation factor (or a scale value) is greater than a pre-defined first threshold level for identifying a presence of the cross-correlation with at least one of the real-time broadcasting signals or with at least one of the pre-recorded database signals, the audio noise optimizer 12 will perform subtracting that at least one of the real-time broadcasting or pre-recorded database signals, properly scaled and synchronized, from the signal 32b to remove the environmental noise from the signal 32b.

Then the audio noise optimizer 12 may check if a resultant signal after the subtracting meets a pre-defined criterion (e.g., the noise is below a further pre-defined threshold), and if the pre-defined criterion is met, generate and send the resultant audio signal 36b to the UE 16-2 which is in a communication session with the UE 14-2. If the pre-defined criterion is not met, the audio noise optimizer 12 may continue looking for other alternative to reduce noise in the signal 32b as shown and explained herein in reference to FIGS. 2a, 2b and 4-5.

It is further noted that any of the UEs 14-1, 14-2, . . . 14-N in FIGS. 1, 2a and 2b and 3 may be a wireless or a wired device. If, for example, UE 14-1 is a wired device, an additional noise source in the audio signal 32, 32a or 32b may be due to a crosstalk noise with other communication wired channels, e.g., due to imperfections in the system (e.g., crosstalk in multiplexers, electro-magnetic coupling, etc.). This interference may be eliminated using the same methodology as described herein in reference to FIGS. 2a, 2b and 3. The candidates for causing the crosstalk (coupling) noise may be chosen by the audio noise optimizer 12 using the “close proximity” principle as described herein or other criteria related to details of the wired communication system design.

FIG. 4 shows an example of a flow chart of the audio noise optimization according to the embodiments of the invention. It is noted that the order of steps shown in FIG. 4 is not absolutely required, so in principle, the various steps may be performed out of the illustrated order. Also certain steps may be skipped or selected steps or groups of steps may be performed in a separate application.

In a method according to this exemplary embodiment, as shown in FIG. 4, in a first step 50 the audio noise optimizer receives a wireless signal from a second UE (UE-2) and converts it into an electrical signal. In a next step 52, the audio noise optimizer identifies a noise signal in the received signal, e.g., during a silent period when the user of the UE-2 is in the listening mode of operation.

In a next step 54, it is determined by the audio noise optimizer whether there are other UEs near to the UE-2 (e.g., using GPS method) which are engaged in active audio related communication. If that is not the case, the process goes to step 76. However, if it is determined in step 54 that there are one of more UEs engaged in active audio communication located near to the UE-2 or in a close proximity to the UE-2 as explained herein, then in step 56 one of these UEs (e.g., UE-1) is selected and then in step 58 it is further determined whether the UE-1 is in a listening (or silent) mode of operation. If it is not the case, i.e., the UE-1 is in the talking mode of operation, the process goes to step 74. However, if it is determined that the UE-1 is in the listening mode, in a next step 60 the audio noise optimizer compares (e.g., correlates in time domain) the noise signal identified in step 52 with the signal sent to the UE-1, e.g., using a time synchronization (e.g., using a variable time delay) as explained in reference to FIG. 2a.

In a next step 62, it is determined by the audio noise optimizer whether the correlation is found, e.g., a correlation factor (or a scale value) is greater than a pre-defined first threshold level for identifying the presence of the cross-correlation as described in reference to FIG. 2a. If that is not the case, in step 66 the audio noise optimizer may select another UE and repeat steps 58 and 60. However, if it is determined that the correlation is found as discussed in reference to FIG. 2a, in a next step 68, the audio noise optimizer subtracts a “noise” which is a properly scaled and synchronized audio signal received by the UE-1 from the signal received from the UE-2 to remove an audio noise (caused by the close proximity of the UE-2 and UE-1). Then in step 70, it is determined by the audio noise optimizer whether the resultant noise after subtraction is below the further pre-defined threshold. If that is the case, the process goes to step 86. However, if it is determined that the resultant noise after subtraction is not below the further pre-defined threshold, the process goes to step 76.

In step 74, for the talking mode of operation, the audio noise optimizer compares (e.g., correlates in time domain) the noise signal (identified in step 52) with the signal received by the audio noise optimizer to be sent to the UE-1, e.g., using a time synchronization (e.g., with a variable time delay) as explained in reference to FIG. 2b and the process goes to step 62. It is noted, that when step 62 is performed after step 74, the correlation may be found as described in reference to FIG. 2b (e.g., using 2 threshold values). Moreover, in step 68 which follows steps 74 and 62, if a proper correlation or a match is found in step 62, i.e., a correlation factor (or a scale value) is greater than a pre-defined first threshold level for identifying a presence of the cross-correlation and, e.g., less than a second threshold level as explained in reference to FIG. 2b, then the audio noise optimizer provides subtracting a “noise” which is a properly scaled and synchronized audio signal received from the UE-1 from the signal received from the UE-2 to remove the audio noise (caused by the close proximity of the UE-2 and UE-1).

It is further noted that if the correlation is not found in step 62 performed after step 74, then, if other UEs are found near to the UE-2 (as determined in step 54), the audio noise optimizer may select another UE near UE-2. However, if all UEs found to be near to the UE-2 are already analyzed, then the process goes to step 76.

In step 76 the audio noise optimizer compares the noise signal (from step 54) or a resultant noise (from step 70) signal with real-time broadcasting signals or pre-recorded database signals, as explained in reference to FIG. 3. In a next step 78, it is determined by the audio noise optimizer whether the correlation with any of these signals is found, e.g., a correlation factor (or a scale value) is greater than a pre-defined first threshold level for identifying the presence of the cross-correlation with at least one signal of the real-time broadcasting or pre-recorded database signals as discussed in reference to FIG. 3. If the correlation is not found, the process goes to step 82. However, if the correlation is found with at least one of the real-time broadcasting or pre-recorded database signals, in a next step 80, the audio noise optimizer will perform subtracting that at least one signal being properly scaled and synchronized from the signal received from the UE-2 to remove the audio noise.

In step 84, it is further determined by the audio noise optimizer whether the resultant noise after subtraction is below the further pre-defined threshold. If that is the case, in a next step 86 the corrected (with canceled/reduced noise) signal is sent by the audio noise optimizer to an intended destination. However, if it is determined that the resultant noise after subtraction is not below the pre-defined threshold, the process may go to step 82 and subsequently to step 88.

In step 82, the remnant noise (e.g., its level being above the further pre-defined threshold) in the signal received from the UE-2, e.g., during the noise (silent or listening) period may be removed by the audio noise optimizer completely during the “silent period” under consideration. This may significantly improve the experience of the user receiving the signal from the UE-2, because at least during the silent period for the UE-2, it would not be any audio noise from the UE-2. Also some known techniques may be used in step 82 to further improve signal quality. For example, the additional noise correction may include (but may not be limited to) identifying and eliminating a noise low frequency component in a frequency domain in the signal received from the UE-2 using a low frequency reject filter. The cut-off frequency of that filter may be determined based on, e.g., FFT (Fast Fourier Transform) analysis, as known in the art.

Finally, in step 88 the audio noise optimizer may select another (e.g., next) silent period as a noise signal in the signal received from the UE-2, and the process may go to step 52 and repeat all or selected steps of steps 52-86 again for this another silent period.

FIG. 8 shows an example of a simplified block diagram of an audio noise optimizer 12 according to an exemplary embodiment of the invention. The audio noise optimizer 12 comprises a noise reduction application module 100, at least one processor 108, at least one memory 120, a storage memory 114 (e.g., for storing pre-recorded signals as explained in reference to FIG. 3 for implementing step 76 in FIG. 4), a UE position determining block 118 (e.g., GPS), at least one transmitter 110 and at least one receiver 112 for transmitting and receiving signals with a audio content to/from the UEs (e.g., in case of the wireless radio operation).

The noise reduction application module 100 comprises at least a noise identifier 102, a comparator/synchronizer 104, and a noise subtractor 106 for implementing exemplary embodiments of the invention demonstrated in FIGS. 2a-2c, 3 and 4. For example, the comparator 14 may be used for implementing step 52 of FIG. 4, the comparator/synchronizer 104 may be used for implementing steps 60, 74 and 76 of FIG. 4, and the noise subtractor 106 may be used for implementing steps 68 and 80 of FIG. 4. A signal 122 can provide real-time broadcasting signals (e.g., TV, radio and the like) to the audio noise optimizer 12 for implementing step 76 of FIG. 4.

The transmitter 110 and the receiver 112 may be generally means for transmitting/receiving and may be implemented as a transceiver, or a structural equivalence (equivalent structure) thereof.

Various embodiments of the at least one memory 120 and/or the storage memory 114 (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 108 include but are not limited to general purpose computers, special purpose computers, microprocessors, digital signal processors (DSPs) and multi-core processors.

The noise reduction application module 100, the module 118 or each of the modules 102, 104 and 106 may be implemented as an application computer program stored, e.g., in the at least one memory 120, but in general it may be implemented as a software, a firmware and/or a hardware module or a combination thereof. In particular, in the case of software or firmware, one embodiment may be implemented using a software related product such as a computer readable memory (e.g., a non-transitory computer readable memory), computer readable medium or a computer readable storage structure comprising computer readable instructions (e.g., program instructions) using a computer program code (i.e., the software or firmware) thereon to be executed by a computer processor.

Furthermore, the module 100, 118, 102, 104 or 106 may be implemented as a separate block or may be combined with any other module/block of the audio noise optimizer 100 or it may be split into several blocks according to their functionality. Moreover, it is noted that all or selected modules of the audio noise optimizer 100 may be implemented using an integrated circuit (e.g., using an application specific integrated circuit, ASIC).

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

What is claimed is:

1. A method comprising:
providing, by an audio noise optimizer, a first electrical signal indicative of an audio signal received from a first user equipment of a plurality of user equipments, each user equipment of the plurality of user equipments being used by a different user;
identifying a noise signal in the first electrical signal;
comparing said noise signal with one or more of:
at least one further electrical signal indicative of at least one further audio signal received from or to be sent to at least one further user equipment of the plurality of user equipments by the audio noise optimizer,
real-time broadcasting signals and
pre-recorded database signals; and
if a match is found between the noise signal and one or more of: the at least one further electrical signal, a real-time broadcasting signal of the real-time broadcasting signals and a pre-recorded database signal of the pre-recorded database signals, subtracting from the first electrical signal one or more appropriately scaled and synchronized versions of: the at least one further signal, the real-time broadcasting signal and the pre-recorded database signal.

2. The method of claim 1, wherein the audio signal and the at least one further audio signals are wireless radio signals.

3. The method of claim 1, wherein the at least one further signal is chosen for said comparing when the at least one further user equipment is in a close proximity to the first user equipment, said close proximity being based on a pre-defined rule.

4. The method of claim 3, wherein said comparing is performed by comparing said noise signal with the at least one further electrical signal when the at least one further audio signal is sent by the audio noise optimizer to the at least one further user equipment, so that the at least one further signal is converted into a further audio signal by the at least one further user equipment, said further audio signal being sensed by a microphone of the first user and consequently converted into a noise component in the first electrical signal which is included in the noise signal, said noise component is to be subtracted from the first electrical signal after said comparing if the match is found.

5. The method of claim 3, wherein said comparing is performed by comparing the noise signal with the at least one further electrical signal when the at least one further audio signal is wirelessly received by the voice optimizer node from the at least one further user equipment, so that a further audio signal generated at the at least one further user equipment is sensed by microphones of the first user equipment and the at the at least one further user equipment, said further audio signal being consequently converted into a noise component in the first electrical signal which is included in the noise signal, said noise component is to be subtracted from the first electrical signal after said comparing if the match is found.

6. The method of claim 1, wherein said comparing is performed by comparing said noise signal with one or more of the real-time broadcasting signals, and if the match is found with at least one real-time broadcasting signal of the real-time broadcasting signals, subtracting said at least one real-time broadcasting signal after being appropriately scaled and synchronized from the first electrical signal.

7. The method of claim 1, wherein said comparing is performed by comparing said noise signal with one or more of the pre-recorded database signals, and if the match is found with at least one pre-recorded database signal of the with pre-recorded database signals, subtracting said at least one with pre-recorded database signal after being appropriately scaled and synchronized from the first electrical signal.

8. The method of claim 1, wherein said identifying the noise signal is performed by identifying a silent time period in said first electrical signal.

9. The method of claim 1, wherein said comparing is performed using cross-correlation in a time domain with time synchronization.

10. The method of claim 1, further comprising:
monitoring a resultant signal after said subtracting, and if the resultant signal meets a pre-defined criterion, generating and sending the resultant audio signal to a second user equipment which is in a communication session with the first user equipment.

11. The method of claim 1, wherein said user equipment is a mobile phone, a camera phone, a video phone, a portable device, a computer or a wired device.

12. The method of claim 1, wherein the voice optimizer is a server, a voice server, a phone server, or a node in a communication system.

13. An apparatus comprising:
an audio noise optimizer; and
at least one processor and at least one memory storing computer readable instructions, said audio noise optimizer, using the computer readable instructions and the at least one processor, is configured to:
provide a first electrical signal indicative of an audio signal received from a first user equipment of a plurality of user equipments, each user equipment of the plurality of user equipments being used by a different user;
identify a noise signal in the first electrical signal;
perform comparing the noise signal with
at least one further electrical signal indicative of at least one further audio signal received from or to be sent to at least one further user equipment of the plurality of user equipments by the audio noise optimizer,
real-time broadcasting signals and
pre-recorded database signals; and
if a match is found between the noise signal and one or more of: the at least one further electrical signal, a real-time broadcasting signal of the real-time broadcasting signals and a pre-recorded database signal of the pre-recorded database signals, subtract from the first electrical signal one or more appropriately scaled and synchronized versions of: the at least one further signal, the real-time broadcasting signal and the pre-recorded database signal.

14. The apparatus of claim 13, comprising:
a receiver configured to receive the audio signal and the at least one further audio signal.

15. The apparatus of claim 13, comprising:
a storage memory configured to store the pre-recorded database signals.

16. The apparatus of claim 13, wherein the audio signal and the at least one further audio signals are wireless radio signals.

17. The apparatus of claim 13, wherein the at least one further signal is chosen for said comparing when the at least one further user equipment is in a close proximity to the first user equipment, said close proximity being based on a pre-defined rule.

18. The apparatus of claim 13, wherein the audio noise optimizer is configured to identify the noise signal by identifying a silent time period in said first electrical signal.

19. The apparatus of claim 13, wherein said audio noise optimizer is configured to perform said comparing using cross-correlation in a time domain with time synchronization.

20. A non-transitory computer readable memory encoded with a computer program comprising computer readable instructions recorded thereon for execution of a method comprising:
providing, by an audio noise optimizer, a first electrical signal indicative of an audio signal received from a first user equipment of a plurality of user equipments, each user equipment of the plurality of user equipments being used by a different user;
identifying a noise signal in the first electrical signal;
comparing said noise signal with one or more of:
at least one further electrical signal indicative of at least one further audio signal received from or to be sent to at least one further user equipment of the plurality of user equipments by the audio noise optimizer,
real-time broadcasting signals and
pre-recorded database signals; and
if a match is found between the noise signal and one or more of: the at least one further electrical signal, a real-time broadcasting signal of the real-time broadcasting signals and a pre-recorded database signal of the pre-recorded database signals, subtracting from the first electrical signal one or more appropriately scaled and synchronized versions of: the at least one further signal, the real-time broadcasting signal and the pre-recorded database signal.
